(19) United States
(12) Patent Application Publication
(10) Pub. No.: US 2011/0111385 A1
(43) Pub. Date: May 12, 2011

(54) AUTOMATED TRAINING SYSTEM AND METHOD BASED ON PERFORMANCE EVALUATION

(75) Inventors: Hari Thiruvengada, Plymouth, MN (US); Anand Tharanathan, Plymouth, MN (US); Liana Maria Kiff, Minnetonka, MN (US); Stephen Douglas Whitlow, St. Louis Park, MN (US)

(73) Assignee: Honeywell International Inc.

(21) Appl. No.: 12/613,735

(22) Filed: Nov. 6, 2009

(51) Int. Cl. G09B 7/00

(52) U.S. Cl. 434/362

(57) ABSTRACT

An automated training system and method based on performance evaluation to provide a precise and succinct automated real-time feedback. A scenario that focuses on specific training objectives can be decomposed into a set of vignettes and dynamically arranged in a dynamic logical sequence to train for a specific high level skill. Performance metrics juxtaposed over a task demand can be automatically computed utilizing a latency and accuracy measure associated with a particular trainee action. Performance data can be automatically gathered and evaluated utilizing the measured performance metrics. Thereafter, contextual feedback information may be automatically organized and provided in real-time to a trainee. The training objectives, the trainee's performance metrics, and feedback data can be utilized to automatically select an appropriate training intervention, which may then be offered to the trainee. An initial, as well as an appropriate follow-up vignette, can be dynamically selected and automatically presented based on the training objectives and evaluated trainee performance data.

### TECHNICAL FIELD

Embodiments are generally related to training systems and methods. Embodiments also relate in general to the field of computers and similar technologies and, in particular, to software utilized in this field. Embodiments are additionally related to automated performance evaluation and feedback for training systems utilized in complex dynamic environments. Embodiments also relate to automated training content (e.g., curriculum) adjustment for training systems based on evaluated performance.

### BACKGROUND OF THE INVENTION

Training systems may be employed in the context of complex dynamic environments such as, for example, battlefield operations, emergency response management, process plant control, firefighting, and so forth. Most prior art training systems have been designed based on a model of presenting trainees with a manually preselected scenario, either in a real-world training setting or through a simulated or gaming environment that focuses on specific, predefined training objectives. Such training systems subsequently measure the trainee's actions and provide for post-hoc performance feedback during a training intervention session with respect to the tasks that are required to accomplish particular role responsibilities. Frequently, automated feedback is augmented with additional input from a human trainer who is executing the training.

Additional training scenarios may then be manually selected by a human trainer from the scenario pool to further measure and evaluate the trainee's skills based on a refined training objective. Such a performance evaluation approach requires manual intervention and does not provide precise and succinct feedback. Also, the performance evaluation in such training systems is elaborate, expensive, time consuming, prone to human and system errors, and evaluator bias. Typically, the training content selection and curriculum readjustment are not automated or dynamically adjusted in real-time based on the training objective and the trainee's performance. In addition, the feedback may be delayed, often out of context and poorly targeted.

Based on the foregoing, it is believed that a need exists for an improved automated training system and method based on performance evaluation for providing a precise and succinct automated real-time feedback. A need also exists for automatically readjusting a training scenario based on the evaluated performance metrics, as described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved automated training system and method.

It is another aspect of the disclosed embodiments to provide for an improved automated training system and method based on performance evaluation, which provides precise and succinct automated real-time feedback.

It is a further aspect of the disclosed embodiments to provide for an improved training system and method for automated real-time training, performance evaluation, real-time feedback, and training intervention with dynamic curriculum adjustment based on evaluated performance metrics.

The aforementioned aspects and other objectives and advantages can now be achieved as described herein. An automated training system and method based on performance evaluation is disclosed, which provides for a precise and succinct automated real-time feedback. A training scenario that focuses on specific training objectives may be decomposed into a set of vignettes and then dynamically arranged in a logical sequence to provide training for specific high level skills. A scenario may be made up vignettes and each vignette may be referred to as a “scene” or may be composed of one or more such scenes. Each vignette follows a script (e.g., made up of several tasks) with a predetermined level of task complexity and can be employed to train one or more specific low level skills that are critical to task accomplishment and contribute to the development of one or more high-level skills. Performance metrics juxtaposed over a task demand may be automatically computed utilizing latency and accuracy measurements associated with a particular trainee action. Note that the term accuracy as utilized herein may relate to the correctness of an action with respect to the task demand. Latency, on the other hand, may relate to the duration elapsed from the time the task demand arises to the time the relevant response/action was performed.

Performance data may be automatically gathered and evaluated utilizing the measured performance metrics. This performance data can also be compared with baseline performance metrics collected from subject matter experts for the same vignette. Thereafter, contextual feedback information may be automatically organized and provided to the trainee in real-time superimposed with baseline performance metrics. The training objectives, the trainee's performance metrics, and feedback data can be utilized to automatically select an appropriate training intervention, which may then be provided to the trainee. A functional feedback component may be employed to visualize the feedback data and record all performance related data in a database for future analysis.

The disclosed automated training system architecture generally includes a vignette library, a curriculum manager module, a performance evaluation module, a feedback functional module, and a curriculum adjustment module. The vignette library comprises of many vignettes that vary in skill and complexity and may be utilized to train for varying low level skills that gradually build toward acquisition of a higher level skill. This vignette library may be added incrementally, so that new situations can be introduced to trainees rapidly, and automatically, by the curriculum manager. The ability to add to the vignette library contributes to the “on the fly nature” of the disclosed embodiments.

Initially, the curriculum manager module may select a default vignette with respect to a targeted skill. The default vignette is interpreted to initialize a time window with respect to any desirable trainee action that is expected to occur within the vignette. Typically, each vignette generally contains multiple time windows that relate to specific tasks. A time window opens at the earliest opportunity to perform a task and then closes when that opportunity ceases to exist. Initial attributed values are then loaded with respect to various objects that are described by the vignette and will be manipulated by the trainee in the training exercise. The performance evaluation module interfaces with a simulation environment and correlates the trainee actions and task demands within the simulation environment to track the status and attributes of various objects.

The feedback module automatically provides the appropriate automated real-time contextual feedback to the trainee and then identifies and highlights instances associated with the performance of the trainee. The trainee can provide additional input using the feedback module based on their subjective perception of how well they performed after the vignette execution completes. The trainee's self assessment would be used to compare their subjective self assessment against an objectively evaluated assessment and provide feedback to improve their situation awareness. The trainee can also provide additional input on the workload using the feedback module. In addition to this, a trainer is also permitted to provide input after the vignette completes. Both trainee and trainer inputs can be presented to the trainee during the training intervention.

The feedback module may also be utilized to record and store the trainee's performance metrics in a persistent database for future review and analysis. That is, baseline metrics and other performance metrics may be calculated, including data indicative of baselining an individual against peers of the same class, and so forth. Such metrics are then stored in the persistent database for later retrieval and analysis.

The computed skills profile, along with the training objectives, can be employed to provide appropriate training intervention to the trainee to improve the performance of a targeted skill. After completion of the current vignette, the curriculum adjustment module dynamically selects an appropriately challenging follow-up vignette based on the trainee's skills profile and training objectives and automatically presents that vignette to the trainee. The process described herein can be repeated until the trainee meets the desired performance level for the targeted skills.

Such an approach provides for the dynamic and automated presentation of a focused training curriculum that targets specific skills based on particular training objectives. The disclosed automated training system and method additionally can be employed to enhance a trainee's learning experience by allowing a flexible method of curriculum (vignette) enhancement, facilitating objective performance evaluation, avoiding evaluator bias during the performance evaluation process, providing contextual real-time and automated performance feedback, streamlining training by focusing of deficient skills and bypassing mastered skills, and improving skill retention. Such a training system and method additionally assists in lowering costs, reducing human and system errors, and compressing training time.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a data-processing system in which an embodiment may be implemented;

FIG. 2 illustrates a schematic view of a software system including an operating system, application software, and a user interface for carrying out an embodiment;

FIG. 3 illustrates a graphical representation of a network of data processing systems in which aspects of the disclosed embodiments may be implemented;

FIG. 4 illustrates a block diagram of an automated performance training system, in accordance with the disclosed embodiments;

FIG. 5 illustrates a functional block diagram of a training system that provides automated real-time training, performance evaluation, feedback and dynamic curriculum adjustment, in accordance with the disclosed embodiments;

FIG. 6 illustrates a process diagram of a training system based on human performance, in accordance with the disclosed embodiments;

FIG. 7 illustrates a high level flow chart of operation illustrating logical operational steps of a method for providing training based on performance evaluation, in accordance with the disclosed embodiments; and

FIG. 8 illustrates a flow chart of operations illustrating logical operational steps of a method for providing automated real-time training, performance evaluation, feedback and dynamic curriculum adjustment, in accordance with the disclosed embodiments.

### DETAILED DESCRIPTION

The particular values and configurations discussed in these non-limiting examples can be varied and are cited merely to illustrate at least one of the disclosed embodiments and are not intended to limit the scope thereof.

The disclosed embodiments automatically provide real-time training, performance evaluation, and feedback and dynamic curriculum adjustment in association with a complex dynamic environment such as, for example, battlefield operations, emergency management, process plant control, firefighting, and so forth. The approach described herein can provide feedback and evaluation data that can then be utilized to counsel and evaluate trainees.

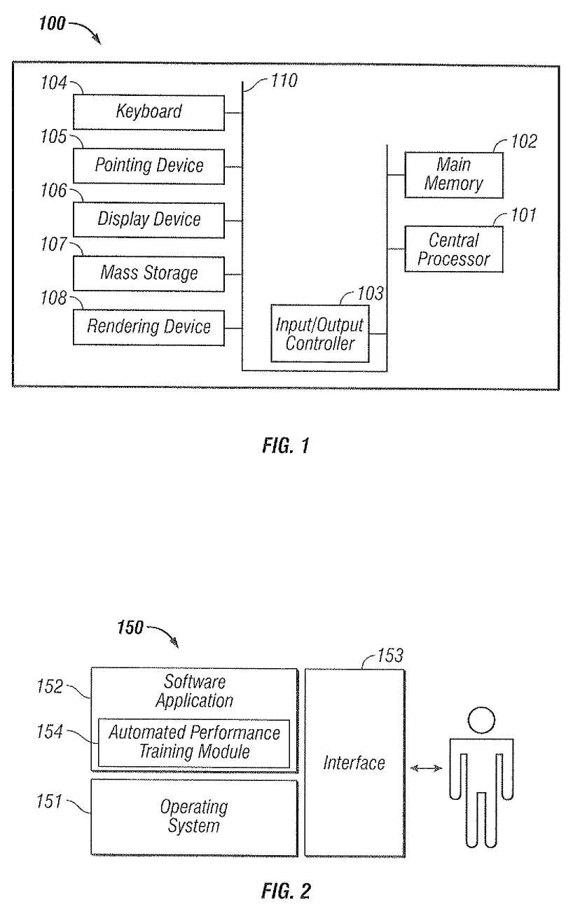

FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the present invention.

As illustrated in FIG. 1, the disclosed embodiments may be implemented in the context of a data-processing system 100 comprising, for example, a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a rendering device 108 (e.g., printer, scanner, fax machine, etc), for example, may be associated with the data-processing system 100 as desired. As illustrated, the various components of data-processing system 100 communicate through a system bus 110 or similar architecture. The system bus 110 may be provided as a subsystem that transfers data between, for example, computer components within data-processing system 100 or between other data-processing devices, components, computers, etc.

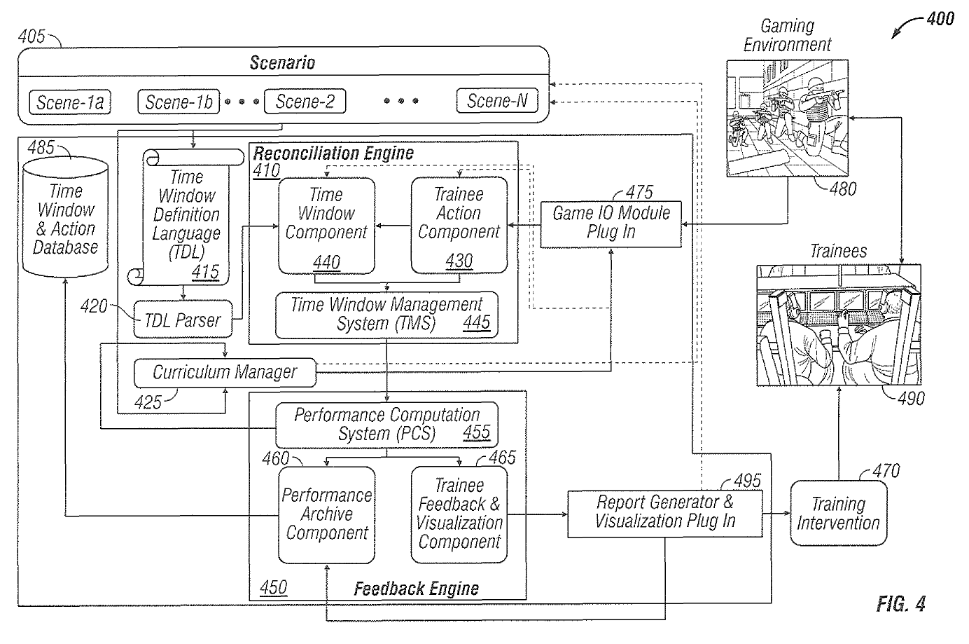

FIG. 2 illustrates a computer software system 150 for directing the operation of the data-processing system 100 depicted in FIG. 1. Software application 152, stored in main memory 102 and in mass storage 107, generally includes a kernel or operating system 151 and a shell or interface 153. One or more application programs, such as software application 152, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating module 151 and/or application module 152. In some applications, particularly with respect to the disclosed embodiments, the software application or module 152 may include an automated performance training module 154, which is described in greater detail herein with respect to FIGS. 4-8.

The following discussion is intended to provide a brief, general description of suitable computing environments in which the system and method may be implemented. Although not required, the disclosed embodiments will be described in the general context of computer-executable instructions, such as program modules, being executed by a single computer.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and includes source code that actually implements the routines in the module. The term module may also simply refer to an application such as a computer program designed to assist in the performance of a specific task such as word processing, accounting, inventory management, etc.

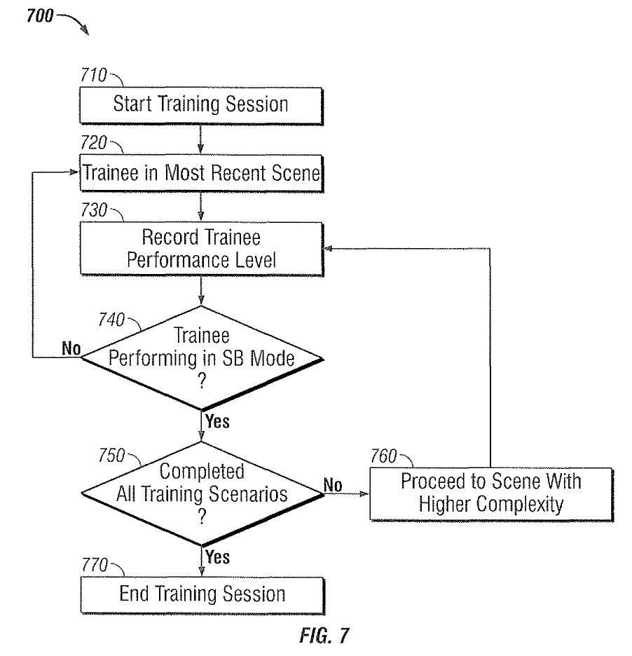

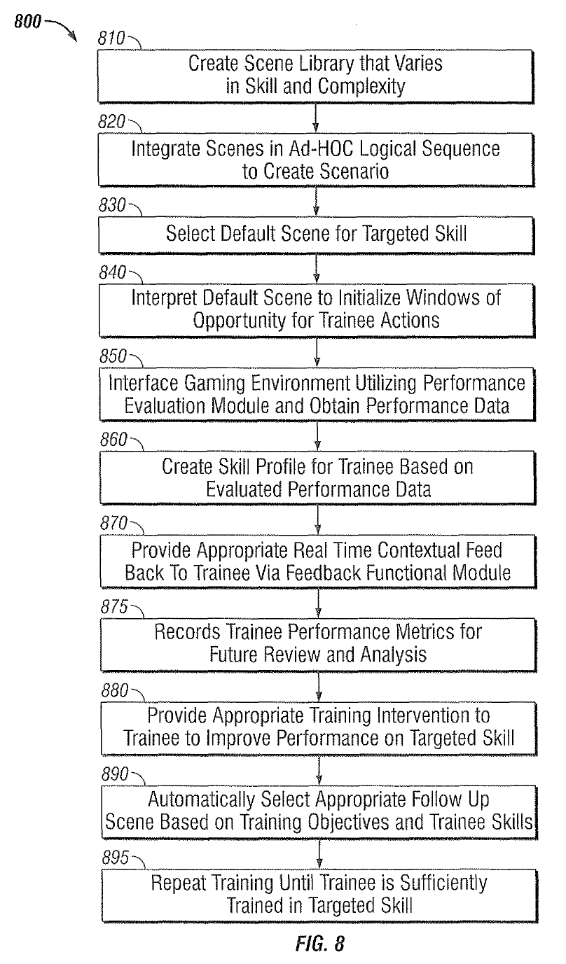

The interface 153, which is preferably a graphical user interface (GUI), can serve to display results, whereupon a user may supply additional inputs or terminate a particular session. In some embodiments, operating system 151 and interface 153 can be implemented in the context of a “Windows” system. It can be appreciated, of course, that other types of operating systems and interfaces may be alternatively utilized. For example, rather than a traditional “Windows” system, other operation systems such as, for example, Linux may also be employed with respect to operating system 151 and interface 153. The software application 152 can include an automated performance training module that can be adapted for providing a closed human-in-the-loop training with an exposure to training scenarios, automated performance evaluation, automated real-time feedback and training intervention, and dynamic curriculum adjustment based on an evaluated performance metrics. Module 152 can be adapted for evaluating the performance objectively to provide precise and succinct automated real-time feedback. Software application module 152, on the other hand, can include instructions such as the various operations described herein with respect to the various components and modules described herein such as, for example, the methods 700 and 800 depicted respectively in FIGS. 7-8 and/or, for example, system 400 depicted in FIG. 4.

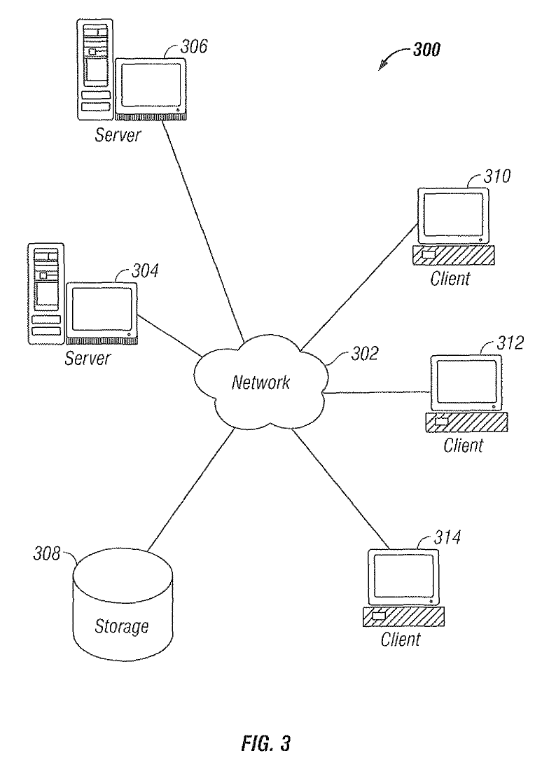

FIG. 3 illustrates a graphical representation of a network of data processing systems in which aspects of the disclosed embodiments may be implemented. Network data processing system 300 is a network of computers in which embodiments of the present invention may be implemented. Network data processing system 300 contains network 302, which is the medium used to provide communications links between various devices and computers connected together within network data processing apparatus 300. Network 302 may include connections such as wire, wireless communication links, or fiber optic cables.

In the depicted example, server 304 and server 306 connect to network 302 along with storage unit 308. In addition, clients 310, 312, and 314 connect to network 302. These clients 310, 312, and 314 may be, for example, personal computers or network computers. Data-processing system 100 depicted in FIG. 1 can be, for example, a client such as client 310, 312, and/or 314. Alternatively, data-processing system 100 can be implemented as a server such as servers 304 and/or 306, depending upon design considerations.

In the depicted example, server 304 provides data such as boot files, operating system images, and applications to clients 310, 312, and 314. Clients 310, 312, and 314 are clients to server 304 in this example. Network data processing system 300 may include additional servers, clients, and other devices not shown. Specifically, clients may connect to any member of a network of servers which provide equivalent content.

In the depicted example, network data processing system 300 is the Internet with network 302 representing a worldwide collection of networks and gateways that use computer communication network protocols to communicate with one another. At the heart of the Internet is a backbone of high-speed data communication lines between major nodes or host computers, consisting of thousands of commercial, government, educational, and other computer systems that route data and messages. Of course, network data processing system 300 may also be implemented as a number of different types of networks such as, for example, an intranet, a local area network (LAN), or a wide area network (WAN). FIG. 3 is intended as an example and not as an architectural limitation for varying embodiments of the present invention.

The description herein is presented with respect to particular embodiments of the present invention, which may be embodied in the context of a data-processing system such as, for example, data-processing system 100 and computer software system 150 illustrated with respect to FIGS. 1-2. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms including Macintosh, UNIX, LINUX, and the like.

FIG. 4 illustrates a block diagram of an automated performance training system 400, in accordance with the disclosed embodiments. System 400 may be implemented as a single module or a group of modules. System 400 may be provided by, for example, the automated performance training module 154 depicted in FIG. 2. The performance training system 400 shown in FIG. 4 generally includes a curriculum manager module 425, a reconciliation engine or module 410, a feedback engine or module 450, and a database 485 in addition to other components which are described in greater detail below.

System 400 additionally includes one or more trainee(s) 490 in addition to the incorporation of a gaming environment or module 480. As indicated in FIG. 4, a training scenario 405 generally includes a group of vignettes (e.g., scene-1a, scene 1b, scene 2 . . . scene-n, etc.), wherein each vignette varies in skill requirements and task complexity. Such vignettes of scenario 405 may be configured to train different low level skills that build up towards a particular higher level skill. Such vignettes can be integrated in a dynamic logical sequence to create the scenario 405, which may be utilized to train for the specific high level skill.

The curriculum manager module 425 selects a default vignette with respect to a targeted skill. Each vignette can be broken down into a set of tasks that represent a time window for the trainee during which the trainee performs a particular action or task. Such time windows may be represented and interpreted through the use of a TDL (Time window Definition Language) 415 utilizing a TDL parser 420 in order to initialize time windows that may exist for a trainee 490 in a specific vignette. The reconciliation engine 410 (e.g., a module) initializes a time window component 440, a trainee action component 430, and a time window management system 445, which loads initial attributed values with respect to various objects. The time window component 440 receives data from the TDL parser and the trainee action component 430. Data output from the trainee action component 430 and the time window component 440 can be supplied as input data to the time window management system 445.

The reconciliation engine 410 may initialize a game I/O (Input/output) module plug-in 475, which generally interfaces with the gaming/simulation environment or module 480 through a network connection such as, for example, the network 302 and system 300 depicted in FIG. 3. The plug-in 475 receives data from the gaming/simulation environment 480 and generates output data, which is supplied to the trainee action component 430 and also back to the gaming environment 480. Note that the term plug-in as utilized herein refers generally to a computer program or other module that interacts with a host application to provide a certain, usually very specific, function “on demand”. The gaming/simulation environment 480 generally transmits an acknowledgment back to the reconciliation engine 410. Such an acknowledgement indicates that the gaming systems associated with the gaming module 480 are ready. The reconciliation engine 410 updates the time window component 440, the trainee action component 430, and the time window management system 445 with current values. Thereafter, the trainee 490 executes the gaming engine so that appropriate data and control messages may then be sent in a standard message format between the reconciliation engine 410 and the gaming/simulation environment 480.

The time window management system 445 correlates actions of the trainee(s) 490 and task demands within the gaming environment 480 to track the status and attributes of various objects. The current vignette may then be exited or paused when a decision is made to provide for training intervention via the training intervention module 470 in the middle or at the end of the current vignette. Specific performance metrics associated with the trainee 490 may be computed based on the training objectives and trainee's actions utilizing a PCS (Performance Computation System) module 455, which forms a part of the feedback engine 450. The feedback engine 450 additionally includes a performance archive component 460 and a trainee feedback and visualization component 465.

The PCS module 455 receives data from the time window management module 445 and generates data, which is supplied as input to the performance archive component 460 and the trainee feedback and visualization component 465. The PCS 455 generally creates a skill profile for the trainee 490 based on his or her measured performance metrics. As indicated previously, a skill profile may be compiled with respect to a particular trainee. Such a computed skill profile can be utilized to provide an appropriate recommendation regarding possible training intervention via training intervention module 470 in order to improve the skills of the trainee 490. The trainee 490 can be automatically provided with real-time feedback through the trainee feedback and visualization module 465 associated with the feedback engine 450. Feedback can be provided to the trainee 490 to identify the performance of the trainee 490.

The trainee's performance metrics may be stored in a persistent database 485 via the performance archive component 460 for future review and analysis. The computed skills profile can be utilized to provide appropriate recommendations regarding an appropriate training intervention by training intervention module 470 that must be provided to the trainee 490 to improve his or her particular skill. Note that feedback data provided to the trainee 490 from the trainee feedback and visualization module 465 is processed by a report generator and visualization plug-in module 495 and then transmitted to the training intervention module 470, which then processes such data and transmits processed data to the trainee 490.

The trainee feedback and visualization module 465 can generate and display via a display device (e.g., display device 106) an instant vignette video replay of, for example, the last 30-60 seconds of the previous vignette after the training is completed to improve the trainee's vignette comprehension, if the vignette is paused to provide the training intervention. The trainee feedback and visualization module 465 can also provide additional feedback to the trainee 490 based on their self rating of performance within a specific vignette as well as their perceived workload, if that information is collected. The trainee feedback and visualization module 465 can also provide additional feedback to the trainee 490 based on the trainer's rating of his or her performance within a specific vignette, if that information is collected.

The computer system architecture of system 400 permits the trainee 490 to improve performance through targeted feedback. Note that a high-level video review of one or more training vignettes may be generated and displayed for the trainee 490 as a part of the feedback to the targeted trainee to provide a broader perspective that could be obtained by simply a first person point of view. That is, the trainee's self assessment could be utilized to compare his or her subjective self assessment against an objectively evaluated assessment and provide feedback to improve his or her situational awareness.

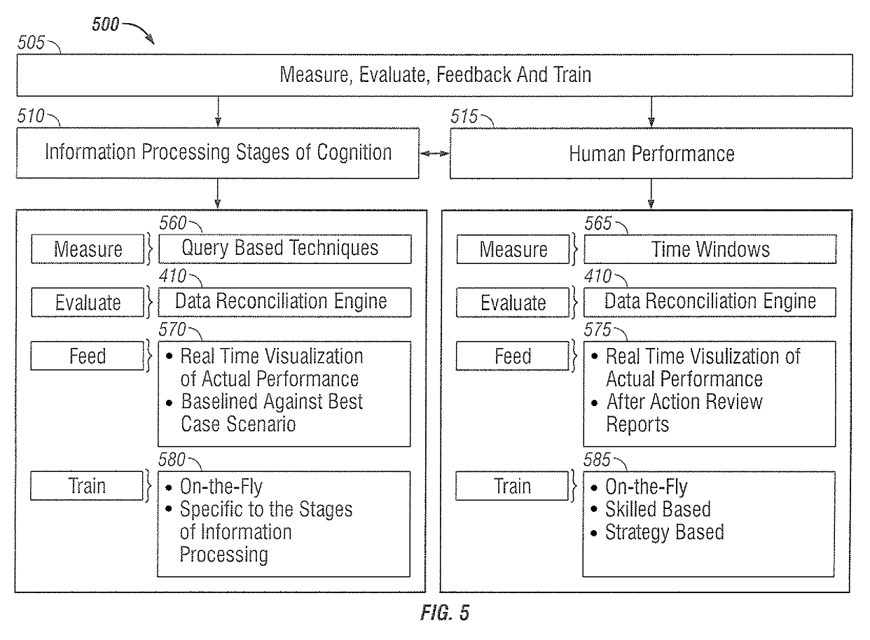

FIG. 5 illustrates a block diagram of a system 500 for providing automated real-time training, performance evaluation, and feedback and dynamic curriculum adjustment, in accordance with the disclosed embodiments. Note that in FIGS. 1-8, identical or similar blocks are generally indicated by identical reference numerals. Note that system 500 operates in association with system 400 discussed earlier. A module 505 may perform measurement, evaluation, feedback, and training with respect to information processing stages of cognition 510 and also a human performance stage 515. The information processing stages of cognition 510 may be measured based on a query based component 560 and evaluated utilizing the reconciliation engine 410. Thereafter, feedback can be provided through real time visualization of actual performance or may be compared to a “best case” scenario, as illustrated at block 570. Note that the term “real time” as utilized herein refers generally to the delivery of data that is “live” and also subject to a delay. For example, there may be a slight delay (e.g., 20-30 seconds) between the transmission and receipt of such data, depending on design considerations. Both cases (live and delayed) are considered “real time”.

Feedback may then be analyzed to automatically provide training specific to the information processing stages of cognition 510, as indicated at block 580. The human performance 515 can be measured by analyzing the time window(s) 565. The human performance 515 may also be evaluated utilizing the data reconciliation engine 410. The performance evaluation can be automated (in an objective manner) utilizing a framework that tracks the accuracy and latency of a trainee's action with respect to the time windows of opportunity that exist for these specific actions to be executed. Thereafter, the feedback can be provided through real time visualization of actual performance or through a trainee's action reports, as illustrated at block 575. Finally, the training can be provided “on the fly” based on skill and strategy, as indicated at block 585.

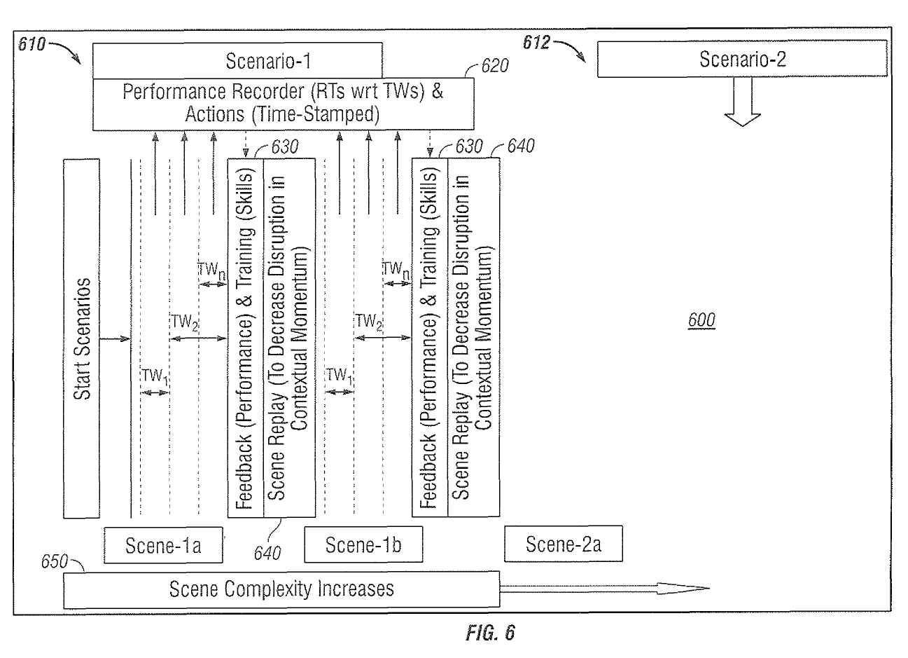

FIG. 6 illustrates a diagram of a process 600 associated with the training system 400 based on the human performance, in accordance with the disclosed embodiments. Initially, a list of scenarios such as, for example, scenario-1, scenario-2, etc., can be created, as illustrated at block 610. A scenario-1 can be decomposed into a set of vignettes that are dynamically arranged in the dynamic logical sequence to train for a specific high level skill. Each scenario may include a group of vignettes such as, for example, scene 1a, scene 1b, etc., which varies in skill and complexity in order to train different low level skills that build up towards the high level skill. The scene-1a and scene-1b associated with scenario 1 as depicted in FIG. 6 can provide a task to the trainee 490 to train for the high level skill. The performance and actions associated with the trainee 490 can then be recorded utilizing a performance recorder 620. A second scenario 612 can also be implemented followed by a third scenario and so on.

The performance of the trainee 490 may be measured with respect to a particular time utilizing time windows such as TW₁, TW₂ . . . TW_{A}. Note that the acronym “TW” as depicted in FIG. 6 generally refers to a time window. Consequently, the trainee 490 receives feedback for his or her performance with respect to each vignette. Necessary training may be provided to the trainee to improve his or her targeted skill, as illustrated at block 630. Thereafter, the vignette replay may be performed to decrease disruption in contextual momentum, as depicted at block 640. The complexity of the vignettes in the scenario-1, for example, increases in order, as illustrated at block 650. If the trainee 490 has acquired a targeted skill by executing scene-1a, for example, the trainee 490 can then execute scene-1b to acquire the next targeted skill. Thereafter, the trainee can start executing the next scenario (e.g., scenario-2) to attain a higher level of skill.

FIG. 7 illustrates a high level flow chart of operation illustrating logical operational steps of a method 700 for providing training based on performance evaluation, in accordance with the disclosed embodiments. Note that the logical operations of method 700 may be implemented as instructions in the context of a module, such as those discussed herein. A training session can be started, as illustrated at block 710. The trainee 490 can perform a most recent vignette associated with the scenario 405 to train with respect to different low level skills that build up toward the higher level skill, as depicted at block 720. The performance level of the trainee 490 may be stored in the persistent database 485 utilizing the performance archive component 460 for future analysis, as illustrated at block 730. Thereafter, a determination can be made as to whether the trainee 490 is in standby (SB), as illustrated at block 740. Note that in SB, the trainee is simply in a state of readiness without being immediately involved.

If the trainee 490 is not performing in the standby mode, the most recent vignette can be executed once again based on the feedback provided by the feedback functional module 465. Otherwise, a determination can be made as to whether all training scenarios have been completed, as depicted at block 750. If all the scenarios are complete, then the training session may be terminated, as depicted at block 770. Otherwise, the trainee 490 may perform the next vignette with higher complexity, which may then be designated as the most recent scene, as illustrated at block 760. The performance details of the trainee 490 can be stored in the database 485.

FIG. 8 illustrates a flow chart of operations illustrating logical operational steps of a method 800 for providing automated real-time training, performance evaluation, feedback, and dynamic curriculum adjustment, in accordance with the disclosed embodiments. Note that the method 800 can be implemented in the context of a computer-useable medium that contains a program product including, for example, a module or group of modules. Thus, the method 800 described herein can be deployed as process software in the context of a computer system or data-processing system as that depicted in FIGS. 1-3.

A vignette library that varies in skill and complexity can be created, as illustrated at block 810. The vignette can then be integrated in a dynamic logical sequence to create a scenario 405, as depicted in block 820. Thereafter, the default scene for the targeted skill may be selected, as indicated at block 830. The default scene can be interpreted utilizing a TDL parser 420 to initialize time windows of opportunity for actions associated with the trainee 490, as illustrated at block 840. The gaming environment 380 can be interfaced utilizing the performance evaluation module 455 and the performance data can be obtained, as depicted at block 850. Note that the vignette library can be added incrementally so that new situations can be introduced to trainees rapidly and automatically by a curriculum manager, thereby promoting the “on the fly” nature of the disclosed embodiments.

Next, the skill profile associated with the trainee 490 can be created by the performance archive component 460 based on the evaluated performance data, as indicated at block 860. The appropriate real time contextual feedback can be provided to the trainee 490 via the feedback functional module 465 associated with the feedback engine 450, as illustrated at block 870. The trainee performance metrics can be stored in the database 485 for future review and analysis, as depicted at block 875. Thereafter, an appropriate training intervention 470 can be provided to the trainee 490 to improve performance on targeted skill, as indicated at the block 880. Finally, an appropriate follow up scene can be selected and automatically presented to the trainee 490 based on the training objectives and the trainee skills profile, as depicted at block 890. The training can then be repeated until the trainee 490 is sufficiently trained in the targeted skill, as shown at block 895.

The performance evaluation can be automated utilizing a framework that tracks the accuracy and latency of the trainee's action with respect to the temporal windows of opportunity that exist for the specific actions to be executed. The training curriculum can be adapted based on the evaluated performance metrics. Such an approach provides a dynamic and automated presentation of focused training curriculum that target the specific skills based on the training objectives. The automated training system 400 enhances the trainee's 490 learning experience by facilitating objective performance evaluation, avoiding evaluator bias during the performance evaluation process, providing contextual real-time performance feedback, and improving skill retention. Such training system 400 also helps lower costs, reduce human and system errors, compress training time, and eliminates wastage.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. An automatic training method, said method comprising:
decomposing a plurality of training vignettes that form a part of a curriculum, wherein each training vignette among said plurality of training vignettes is arranged in a dynamic logical sequence with respect to a particular high level skill desired to be attained by a trainee utilizing said curriculum;
arranging each training vignette among said plurality of training vignettes based on a predetermined level of complexity of actions to be performed by said trainee during a participation of said trainee in said curriculum; and
training said trainee utilizing said plurality of training vignettes in order to teach said trainee to develop specific low level skills that are critical to learning and attaining said particular high level skill.

2. The method of claim 1 further comprising generating and displaying a high-level video review of at least one training vignette among said plurality of vignettes as a part of feedback to said trainee to provide a broad perspective to said trainee for use in developing said specific low level skills for learning and attaining said particular high level skill.

3. The method of claim 1 further comprising measuring an acquisition of behavioral skills by said trainee based on latency and accuracy data associated with actions of said trainee with respect to said curriculum in order to dynamically adjust said curriculum.

4. The method of claim 1 further comprising evaluating performance metrics measured with respect to said trainee including integration and consideration of subjective feedback in association with measured feedback thereof.

5. The method of claim 1 further comprising:
selecting an appropriate training intervention based on feedback and performance metrics measured with respect to trainee; and
recording said performance metrics in a database for future analysis of said performance metrics.

6. The method of claim 1 further comprising automatically organizing and providing focused contextual feedback data automatically in real-time to said trainee.

7. An automated training system, said system comprising:
a performance evaluation module that interfaces with a simulation environment to obtain performance data associated with a trainee and correlates data indicative of a trainee action and a task demand with respect to said simulation environment to track a status and at least one attribute of a plurality of objects;
a feedback functional module that communicates with said performance evaluation module and which automatically provides appropriate automated real-time contextual feedback based on said performance data during a training intervention and records performance metrics associated with said trainee in a persistent database for future review and analysis; and
a curriculum adjustment module for dynamically selecting an appropriate follow-up vignette based on a skill profile and a training objective to thereafter automatically present said follow-up vignette to said trainee to dynamically and automatically present a focused training curriculum that targets said skill profile based on said training objective, wherein said performance module, said feedback functional module, and said curriculum adjustment module are storable in a computer memory and retrievable for processing by a computer processor.

8. The system of claim 7 further comprising a vignette library comprising a plurality of vignettes, which each vignette among said plurality vignettes varies in skill and complexity in order to train for a plurality of low level skills that build towards a high level skill.

9. The system of claim 8 wherein said plurality of vignettes is integrated in a dynamic logical sequence to create a scenario for training for said high level skill.

10. The system of claim 7 further comprising a curriculum manager module for selecting a default vignette for a targeted skill.

11. The system of claim 7 further comprising a time window definition language parser that interprets said plurality of vignettes to initialize a window of opportunity that exists with respect to a specific vignette.

12. The system of claim 7 further comprising a reconciliation engine that loads said initial attribute value associated with said plurality of objects.

13. The system of claim 12 wherein said reconciliation engine further comprises:
a time window component;
a trainee action component; and
a time window management unit.

14. The system of claim 7 further comprising a performance archive that records said trainee performance metrics in said persistent database.

15. The system of claim 7 further comprising a game I/O module comprising a plug-in module that interfaces with said simulation environment through a network connection to obtain measurable behavior indicators and actions from a simulated environment for evaluation.

16. An automated training system, said system comprising:
a processor;
a data bus coupled to said processor; and
a computer-usable medium embodying computer code, said computer-usable medium being coupled to said data bus, said computer program code comprising instructions executable by said processor and configured for:
decomposing a plurality of training vignettes that form a part of a curriculum, wherein each training vignette among said plurality of training vignettes is arranged in a dynamic logical sequence with respect to a particular high level skill desired to be attained by a trainee utilizing said curriculum;
arranging each training vignette among said plurality of training vignettes based on a predetermined level of complexity of actions to be performed by said trainee during a participation of said trainee in said curriculum; and
training said trainee utilizing said plurality of training vignettes in order to teach said trainee to develop specific low level skills that are critical to learning and attaining said particular high level skill.

17. The system of claim 16 wherein said instructions are further configured for generating and displaying a high-level video review of at least one training vignette among said plurality of vignettes as a part of feedback to said trainee to provide a broad perspective to said trainee for use in developing said specific low level skills for learning and attaining said particular high level skill.

18. The system of claim 16 wherein said instructions are further configured for measuring an acquisition of behavioral skills by said trainee based on latency and accuracy data associated with actions of said trainee with respect to said curriculum in order to dynamically adjust said curriculum.

19. The system of claim 16 wherein said instructions are further configured for evaluating performance metrics measured with respect to said trainee including integration and consideration of subjective feedback in association with measured feedback thereof.

20. The system of claim 16 wherein said instructions are further configured for:
selecting an appropriate training intervention based on feedback and performance metrics measured with respect to trainee; and
recording said performance metrics in a database for future analysis of said performance metrics.
